(19) United States
(12) Patent Application Publication
(10) Pub. No.: US 2007/0163114 A1
(43) Pub. Date: Jul. 19, 2007

(54) Methods for fabricating components

(75) Inventor: Michael R. Johnson, Loveland, OH (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/332,532

(22) Filed: Jan. 13, 2006

(51) Int. Cl. B23P 15/04

(52) U.S. Cl. 29/889.2

(57) ABSTRACT

A method for fabricating an assembly having an airfoil extending radially outwardly from a member includes determining three-dimensional information of the airfoil, converting the three-dimensional information into a plurality of slices that each define a cross-sectional layer of the airfoil, successively forming each layer of the airfoil by fusing a metallic powder using laser energy, and coupling the airfoil to the member such that the airfoil extends radially outward from the member.

### BACKGROUND OF THE INVENTION

This invention relates generally to stator and/or rotor assemblies, and more specifically to methods for fabricating stator and/or rotor assemblies.

At least some known gas turbine engines include a compressor, a combustor, and at least one turbine. The compressor compresses air which is mixed with fuel and channeled to the combustor. The mixture is then ignited for generating hot combustion gases, and the combustion gases are channeled to the turbine which extracts energy from the combustion gases for powering the compressor, as well as producing useful work to propel an aircraft in flight or to power a load, such as an electrical generator.

The turbine includes a rotor assembly and a stator assembly. The rotor assembly includes a plurality of airfoils, sometimes referred to as rotor blades, extending radially outward from a disk. More specifically, each rotor blade extends radially between a platform adjacent the disk, to a tip. A combustion gas flowpath through the rotor assembly is bound radially inward by the rotor blade platforms, and radially outward by a plurality of shrouds.

The stator assembly includes a plurality of airfoils, sometimes referred to as stator vanes, which form a nozzle, sometimes referred to as a turbine nozzle, which directs the combustion gases entering the turbine to the rotor blades. The stator vanes extend radially between a root platform and a tip. The tip includes an outer band that mounts the stator assembly within the engine.

During operation, the turbine stator and rotor assemblies are exposed to hot combustion gases. Over time, continued exposure to hot combustion gases increases an operating temperature of the rotor assembly, which may cause damage to components thereof. Accordingly, to facilitate reducing operating temperatures of the rotor blade tips, at least some known rotor assemblies include pre-swirl cooling air systems wherein one or more pre-swirl nozzles swirls cooling air discharged into radial passages in the rotor blades. The cooling air flows through the rotor blades and is exhausted radially outward through the tip of the blade. Pre-swirl nozzles may also sometimes be used with test equipment used to test rotor and/or stator assembly components. For example, at least some know pre-swirl nozzles expand and thereby accelerate cooling air upstream from a turbine nozzle to facilitate testing parameters of the turbine nozzle such as, but not limited to, flow loss and/or performance. At least some known pre-swirl nozzles include a plurality of circumferentially spaced airfoils, or blades, coupled together by radially inner and outer bands.

However, at least some known stator and/or rotor assemblies may be time-consuming to fabricate, which may facilitate an increased cycle time and/or cost of fabricating the assembly. For example, at least some known rotor blades, pre-swirl nozzle blades, and/or stator vanes are airfoils that have a relatively complex three-dimensional geometry. At least some known methods for fabricating such blades and/or vanes include forging, casting, and/or machining the blade and/or vane from bar stock. However, such known methods for fabricating blades and/or vanes may be time-consuming and thereby possibly increase a cycle time of fabricating the rotor, pre-swirl nozzle, and/or turbine nozzle.

### BRIEF SUMMARY OF THE INVENTION

In one aspect, a method is provided for fabricating an assembly having an airfoil extending radially outwardly from a member. The method includes determining three-dimensional information of the airfoil, converting the three-dimensional information into a plurality of slices that each define a cross-sectional layer of the airfoil, successively forming each layer of the airfoil by fusing a metallic powder using laser energy, and coupling the airfoil to the member such that the airfoil extends radially outward from the member.

In another aspect, a method is provided for fabricating an airfoil. The method includes determining three-dimensional information of the airfoil, converting the three-dimensional information into a plurality of slices that each define a cross-sectional layer of the airfoil, and successively forming each layer of the airfoil by fusing a metallic powder using laser energy.

### BRIEF DESCRIPTION OF THE DRAWINGS

FIG. 1 is a schematic illustration of an exemplary turbine nozzle test assembly.

FIG. 2 is a perspective view of an exemplary pre-swirl nozzle for use with the turbine nozzle test assembly shown in FIG. 1.

FIG. 3 is a flowchart illustrating an exemplary embodiment of a method for fabricating the pre-swirl nozzle shown in FIG. 2.

### DETAILED DESCRIPTION OF THE INVENTION

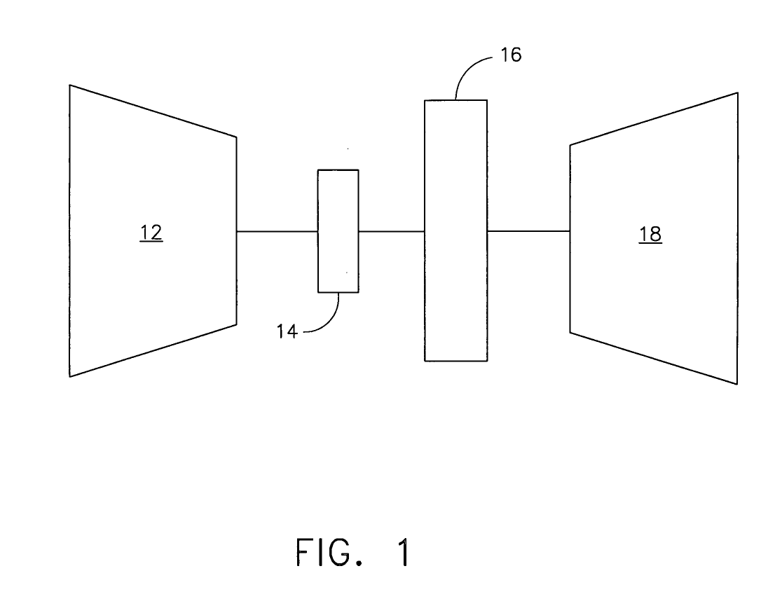

FIG. 1 is a schematic illustration of an exemplary turbine nozzle test assembly 10. Assembly 10 includes an inlet 12, a pre-swirl nozzle 14, a turbine nozzle 16, and an outlet arranged in a serial flow relationship. In operation, air flows through inlet 12 and pre-swirl nozzle 14. Pre-swirl nozzle 14 expands and thereby accelerates the air upstream from turbine nozzle 16. Air swirled by is channeled through turbine nozzle 16 to evaluate a parameter of turbine nozzle 16, such as, but not limited to, a flow loss of nozzle 16 and/or a performance of nozzle 16.

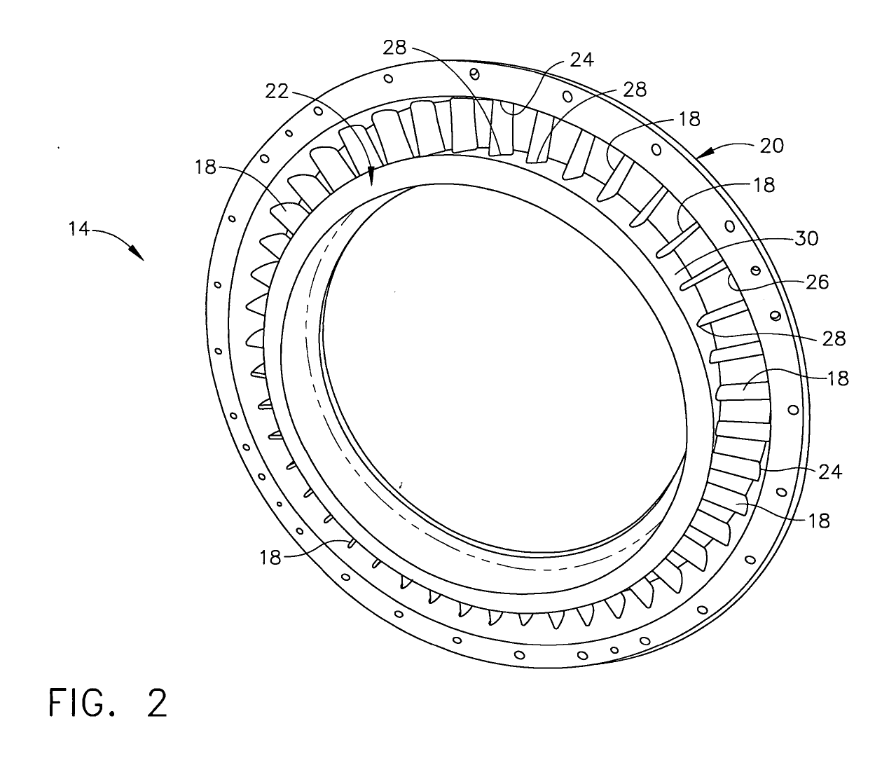

FIG. 2 is a perspective view of an exemplary pre-swirl nozzle 14 for use with the turbine nozzle test assembly 10 (shown in FIG. 1). Pre-swirl nozzle 14 includes a plurality of circumferentially spaced airfoils 18, sometimes referred to as blades, coupled together by an annular radially outer band 20 and an annular radially inner band 22. More specifically, each airfoil 18 extends between an airfoil tip 24 coupled to a radially inner surface 26 of outer band 20 and an airfoil root 28 coupled to a radially outer surface 30 of inner band 22. Outer band 20 is circumferentially coupled to a housing (not shown) of turbine nozzle test assembly 10. In the exemplary embodiment, outer band radially inner surface 26 and inner band radially outer surface 30 define a flow path for air to flow through pre-swirl nozzle 14. In the exemplary embodiment, the air flow is channeled through pre-swirl nozzle 14 to turbine nozzle 16 (shown in FIG. 1).

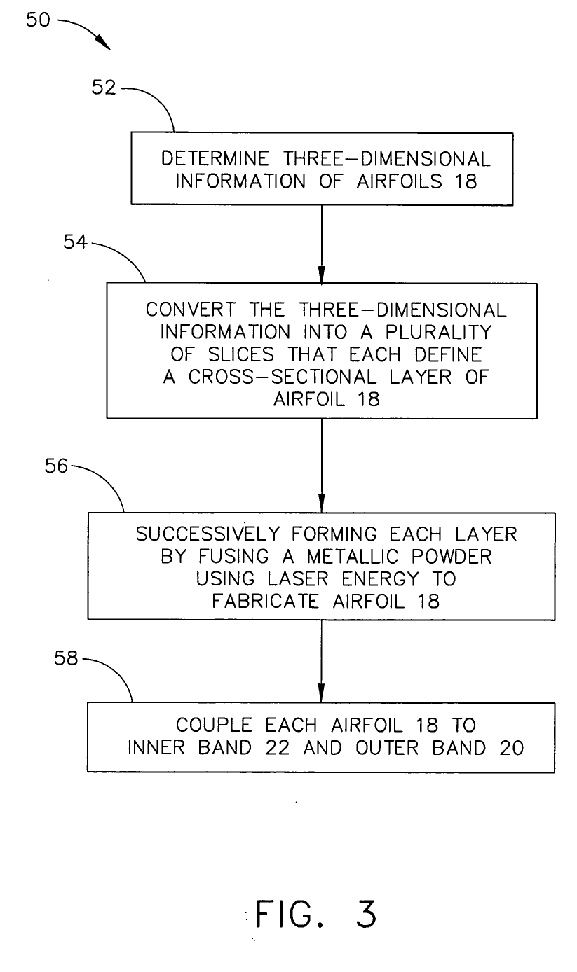

FIG. 3 is a flowchart illustrating an exemplary embodiment of a method 50 for fabricating pre-swirl nozzle 14. Method 50 includes fabricating airfoils 18 (shown in FIG. 2) using Direct Metal Laser Sintering (DMLS). DMLS is a known manufacturing process that fabricates metal components using three-dimensional information, for example a three-dimensional model, of the component. The three-dimensional information is converted into a plurality of slices that each defines a cross section of the component for a predetermined height of the slice. The component is then “built-up” slice by slice, or layer by layer, until finished. Each layer of the component is formed by fusing a metallic powder using a laser.

Accordingly, method 50 includes determining 52 three-dimensional information of each airfoil 18 (shown in FIG. 2) and converting 54 the three-dimensional information into a plurality of slices that each define a cross-sectional layer of airfoil 18. Airfoils 18 are then each fabricated using DMLS, or more specifically each layer is successively formed 56 by fusing a metallic powder using laser energy. Airfoils 18 may be fabricated using any suitable laser sintering machine. Examples of suitable laser sintering machines include, but are not limited to, an EOSINT® M 270 DMLS machine and/or an EOSINT® M 250 Xtended DMLS machine, each available from EOS of North America, Inc. of Novi, Mich. The metallic powder used to fabricate airfoils 18 may be any suitable metallic powder, such as, but not limited to, a powder including DirectMetal® 20, DirectSteel® 20, DirectSteel® H20, cobalt chromium, bronze steel, and/or titanium alloys such as, but not limited to, Ti-318 (Ti—Al6-V4).

Once airfoils 18 have been fabricated, each airfoil 18 is coupled 58 to inner and outer bands 22 and 20 (shown in FIG. 2), respectively, such that airfoils 18 are spaced-apart circumferentially and extend radially between inner and outer bands 22 and 20, respectively. For example, in the exemplary embodiment each airfoil tip 24 (shown in FIG. 2) is coupled to outer band radially inner surface 26 (shown in FIG. 2) and each airfoil root 28 (shown in FIG. 2) is coupled to inner band radially outer surface 30 (shown in FIG. 2). In some embodiments, at least a portion of each airfoil tip 24 is received within a corresponding slot (not shown) within outer band 20, and each airfoil root 28 is received within a slot (not shown) within inner band 22. A location and/or orientation of each airfoil 18 relative to inner and outer bands 22 and 20, respectively, may be selected to facilitate imparting a predetermined swirl to air flowing between inner and outer bands 22 and 20, respectively. Airfoils 18 may be coupled 58 to inner and outer bands 22 and 20, respectively, using any suitable method, process, and/or means, such as, but not limited to, welding. Although any suitable welding process may be used, examples of suitable welding processes include, but are not limited to, tack-welding and brazing each airfoil 18 to inner and outer bands 22 and 20, respectively. In addition or alternative to brazing, each airfoil 18 may be sealed to bands 22 and 20 using any suitable cement, such as, but not limited to, Sauereisen® Cement 31 available from Sauereisen of Pittsburgh, Pa.

By fabricating airfoils 18 using DMLS, the methods described and/or illustrated herein may facilitate reducing a time of fabricating airfoils 18 as compared with at least some known methods for fabricating airfoils. As such, the methods described and/or illustrated herein may facilitate reducing a cycle time for fabricating a rotor and/or a stator assembly, such as, but not limited to, pre-swirl nozzle 14.

Although the methods described and/or illustrated herein are described and/or illustrated with respect to a pre-swirl nozzle, and more specifically a pre-swirl nozzle for use with a turbine nozzle test assembly, practice of the methods described and/or illustrated herein is not limited to pre-swirl nozzles, nor components for used with testing assemblies. Rather, the methods described and/or illustrated herein are applicable to fabricating any stator and/or rotor assembly having an airfoil.

Exemplary embodiments of methods, nozzles, and airfoils are described and/or illustrated herein in detail. The nozzles, airfoils and methods are not limited to the specific embodiments described herein, but rather, components of each nozzle and components of each airfoil, as well as steps of each method, may be utilized independently and separately from other components and steps described herein. Each component, and each method step, can also be used in combination with other components and/or method steps.

When introducing elements/components/etc. of the methods and/or nozzles described and/or illustrated herein, the articles “a”, “an”, “the” and “said” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. A method for fabricating an assembly having an airfoil extending radially outwardly from a member, said method comprising:
determining three-dimensional information of the airfoil;
converting the three-dimensional information into a plurality of slices that each define a cross-sectional layer of the airfoil;
successively forming each layer of the airfoil by fusing a metallic powder using laser energy; and
coupling the airfoil to the member such that the airfoil extends radially outward from the member.

2. A method in accordance with claim 1 wherein determining three-dimensional information of the airfoil further comprises determining a three-dimensional model of the airfoil.

3. A method in accordance with claim 1 wherein successively forming each layer of the airfoil by fusing a metallic powder using laser energy further comprises fusing a powder comprising at least one of cobalt chromium, bronze steel, titanium, steel, copper, iron, tungsten, nickel, silicon, tin, and phosphorous.

4. A method in accordance with claim 1 wherein coupling the airfoil to the member further comprises welding the airfoil to the member.

5. A method in accordance with claim 4 wherein welding the airfoil to the member further comprises tack welding the airfoil.

6. A method in accordance with claim 1 further comprising brazing a portion of the airfoil and a portion of the member to facilitate coupling the airfoil to the member.

7. A method in accordance with claim 1 further comprising applying a cement to a portion of the airfoil and a portion of the member to facilitate coupling the airfoil to the member.

8. A method in accordance with claim 1 wherein coupling the airfoil to the member further comprises coupling the member to a rotor disk.

9. A method in accordance with claim 1 wherein coupling the airfoil to the member further comprises coupling the airfoil to a radially inner band and a radially outer band of a stator assembly such that the airfoil extends radially between the radially inner and outer bands.

10. A method in accordance with claim 9 wherein coupling the airfoil to a radially inner band and a radially outer band of a stator assembly further comprises coupling a tip of the airfoil to a radially inner surface of the radially outer band and coupling a root of the airfoil to a radially outer surface of the radially inner band.

11. A method for fabricating an airfoil, said method comprising:
determining three-dimensional information of the airfoil;
converting the three-dimensional information into a plurality of slices that each define a cross-sectional layer of the airfoil; and
successively forming each layer of the airfoil by fusing a metallic powder using laser energy.

12. A method in accordance with claim 11 wherein determining three-dimensional information of the airfoil further comprises determining a three-dimensional model of the airfoil.

13. A method in accordance with claim 11 wherein successively forming each layer of the airfoil by fusing a metallic powder using laser energy further comprises fusing a powder comprising at least one of DirectMetal 20, DirectSteel 20, DirectSteel H20, and/or titanium.
